(19) United States
(12) Patent Application Publication
(10) Pub. No.: US 2017/0131978 A1
(43) Pub. Date: May 11, 2017

(54) AUTOMATED OFFLINE APPLICATION (APP) GENERATION SYSTEM AND METHOD THEREFOR

(71) Applicant: appsFreedom Inc., CHANDLER, AZ (US)

(72) Inventors: VAIDYANATHAN IYER, CHANDLER, AZ (US); VIKAS GUPTA, NAPERVILLE, IL (US)

(73) Assignee: appsFreedom Inc., CHANDLER, AZ (US)

(21) Appl. No.: 15/345,267

(22) Filed: Nov. 7, 2016

Related U.S. Application Data
(60) Provisional application No. 62/251,807, filed on Nov. 6, 2015.

(51) Int. Cl. G06F 9/44; G06F 3/0486

(52) U.S. Cl. CPC G06F 8/34; G06F 8/35; G06F 3/0486

(57) ABSTRACT

A method of automatically generating an app with an app generation system comprising: defining an app type; defining a business process using a logical process model; automatically generating an app for a plurality of device operating systems and browsers in response to activating an app generation software application; enhancing the visual aspects of screens of the generated app; building integration logic using a drag and drop interface; publishing and managing the generated app; and analyzing user behavior, wherein the generation of the app includes providing automatic reporting of user behavior in use of the generated app.

### RELATED APPLICATIONS

The present patent application claims the benefit of U.S. Provisional Application No. 62/251,807, filed Nov. 6, 2015, entitled “AUTOMATED OFFLINE APP GENERATION SYSTEM” in the name of the same inventors, and which is incorporated herein by reference in its entirety. The present patent application is also related to U.S. patent application Ser. No. 14/942,670, filed Nov. 16, 2015, entitled “AUTOMATED OFFLINE APP GENERATION SYSTEM”, and which is incorporated herein by reference in its entirety.

### TECHNICAL FIELD

The present application in general relates to an application (app) development platform and more particularly to an automated app development platform that provides a unique way for anyone, without any programming skills, to build and deploy offline apps.

### BACKGROUND

The development of apps for computing devices and particularly mobile computing devices is becoming more important within businesses. Businesses seek to develop apps in order to improve productivity by giving the businesses the ability to simplify the tasks of various employees of the business by developing an app that helps in the performance of the employees responsibilities. Unfortunately, it is generally difficult to develop and create apps if one has little to no experience in doing so. Generating apps frequently requires a substantial human resource investment as well as a large financial and time investment. Currently, there is not a system that allows a user with no programming experience to be able to develop an app.

Therefore, it would be desirable to provide a system and method that overcomes the above. The system and method would that allows a user with no programming experience to be able to develop an app.

### SUMMARY

In accordance with one embodiment, a method of automatically generating an app with an app generation system is disclosed. The method comprising: defining an app type; defining a business process using a logical process model; automatically generating an app for a plurality of device operating systems and browsers in response to activating an app generation software application; enhancing the visual aspects of screens of the generated app; building integration logic using a drag and drop interface; publishing and managing the generated app; and analyzing user behavior, wherein the generation of the app includes providing automatic reporting of user behavior in use of the generated app.

The foregoing and other features and advantages of the present invention will be apparent from the following more detailed description of the particular embodiments of the invention, as illustrated in the accompanying drawings

### BRIEF DESCRIPTION OF THE DRAWINGS

The present application is further detailed with respect to the following drawings. These figures are not intended to limit the scope of the present invention but rather illustrate certain attributes thereof.

FIG. 1 is a view of a process modeler of an app generation system according to one aspect of the present application;

FIG. 2 is a view of an app designer module of an app generation system according to one aspect of the present application;

FIG. 3 is a view of an integration builder of an app generation system according to one aspect of the present application;

FIG. 4 is a view of a platform configurator of an app generation system according to one aspect of the present application;

FIG. 5 is a view of a management development interface of an app generation system according to one aspect of the present application;

FIG. 6 is a diagrammatic view of an architecture of a delegated business process management for the Internet of Things according to one aspect of the present application;

FIG. 7 is a flow chart of a business process according to one aspect of the present application;

FIG. 8 is a view of an app definition screen of an app generation system according to one aspect of the present application; and

FIG. 9 is a diagrammatic view of extended offline app components according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the present invention relate to an app development platform that provides a unique way for anyone, without any programming skills, to build and deploy apps in 5 easy steps. Typically the entire end-to-end 5 step process from app conceptualization to app deployment can be done in 5 days or less. The platform is a Model-Driven platform that guides anyone with no programming skills through the 5 following steps.

The 5 steps may include define the process (Step 1); enhance the screens (Step 2); build integration logic (Step 3); publish and manage (Step 4); and analyze user behavior (Step 5).

Step I: Define the Process

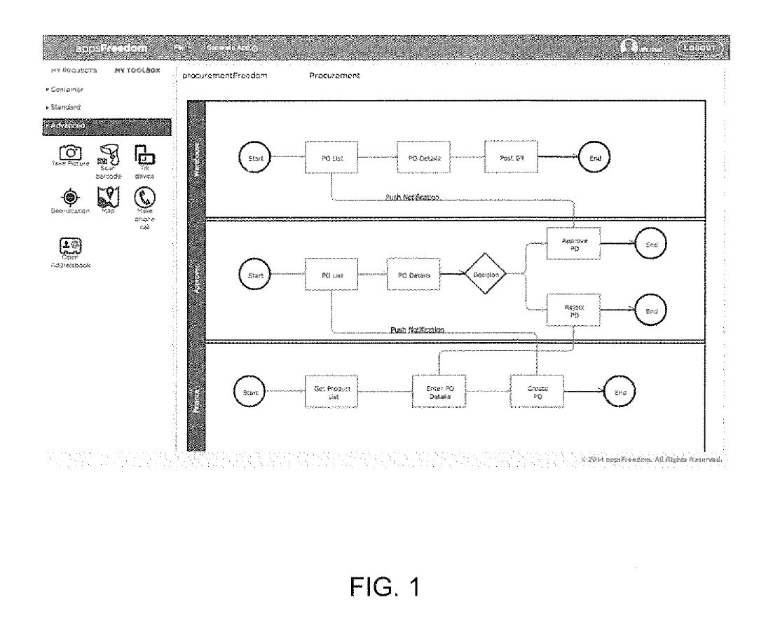

In the system platform, a user may access the Process Modeler, shown in FIG. 1, and define the business processes for the app to be created. The focus should be on the logical process model, not on User Interface (UI) or backend systems and data. The primary step is to get the processes completely defined as this may ensure that the app is designed exactly the way the end-user requires without compromising on user experience, or UX. Unlike other app development systems, embodiments of the system platform may allow for a model of a business process to be the foundation for the automated generation of an app.

A user click on a “GENERATE” button in the Process Modeler generates the base app framework for all device operating systems (i.e iOS, Android, Blackberry, Windows smartphones & tablets) and the browser. At this point, a user has an app with all the logic and navigation flow embedded. However, it will not have all the desired screen elements or cosmetic look and feel of the user interface at this step.

Step 2: Enhance the Screens

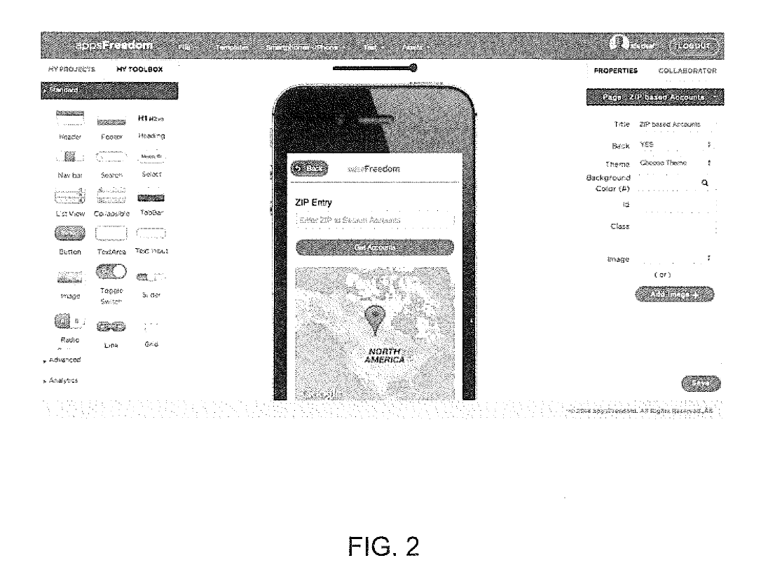

The user may then access the App Designer Module, as depicted in FIG. 2, in the system platform and open the app that was generated from the Process Modeler. This app may have various pages, and the relationship between them, if there is such. In the App Designer, a user can open each page and can drag-n-drop mobile components into the UI. The mobile components can be from simple elements like dropdown and text boxes to more advanced elements like charts and bar-code scanners. Any enhancement should need to be made only once and the system applies any enhancement made in one operating system app to all the devices and browsers operating in different operating systems. All the app enhancements can be reviewed in real-time by business users from their devices for real-time feedback to the app developer.

Step 3: Build Integration Logic

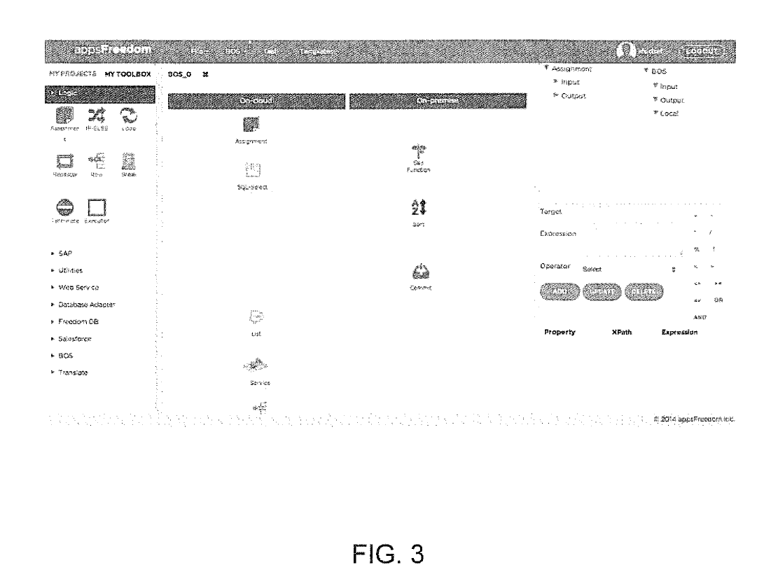

For this task, the Integration Builder may be opened, as seen in FIG. 3 in the system Platform. The Integration Builder may allow one to start building the integration logic for the generated app. This may include connecting to a cloud backend application or an on-premise backend application or to no external application at all, depending on the specific requirements of the app. This activity may include building the business and integration logic required by the app. All business and integration logic may be done via drag-n-drop components in the integration builder. The app development process is complete at this step.

Step 4: Publish and Manage

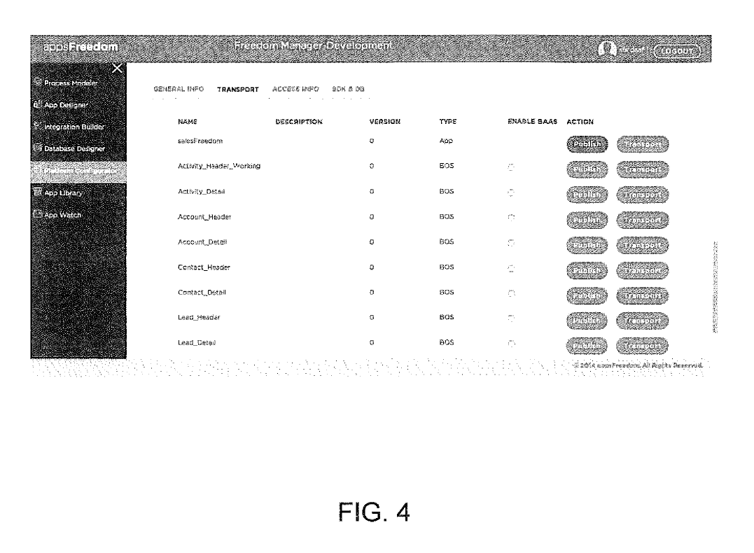

In this step, one may publish the app using the Platform Configurator module of the system Platform, as shown in FIG. 4. In this step administration tasks such as user definition and role assignment can be leveraged from the backend identity management servers. This module may also include testers into the process to test the app before publishing and rolling it out to production users and managing it.

Step 5: Analyze User Behavior

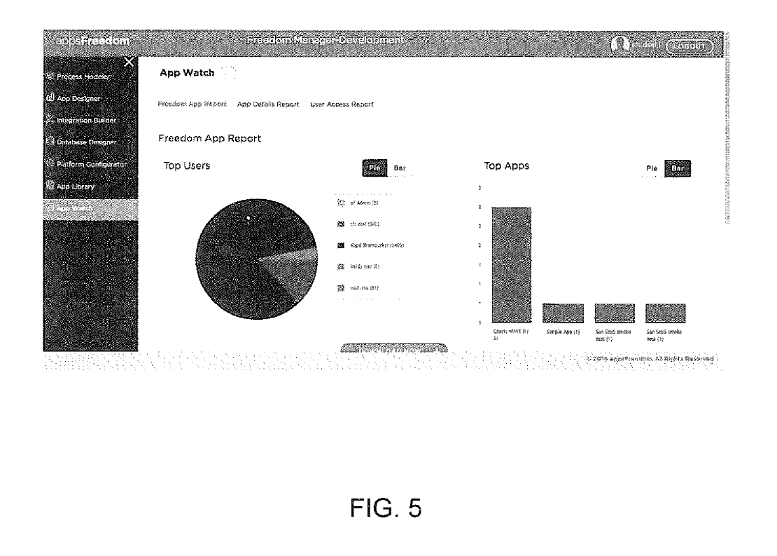

Once business users have downloaded and deployed the app, the apps may automatically provide all usage statistics to the platform where the developer or administrator can analyze usage and user behavior patterns to update the app with improvements using a management development interface as depicted in FIG. 5.

The system Platform may support the complete app development lifecycle with this 5 step process. All of the steps of the process may be provided by the use of a software application that provides a user interface for each step. Based on the information entered by the user at the beginning with the business process model, the software application may automatically generate an app that performs the functionality to accomplish the business process. There is no need for a user to code and debug the code in order to create a working app.

Embodiments may also operate on a delegated business process management for the Internet of Things. Generally, the delegated business process management process allows for smart devices to delegate performance of a task to another smart device.

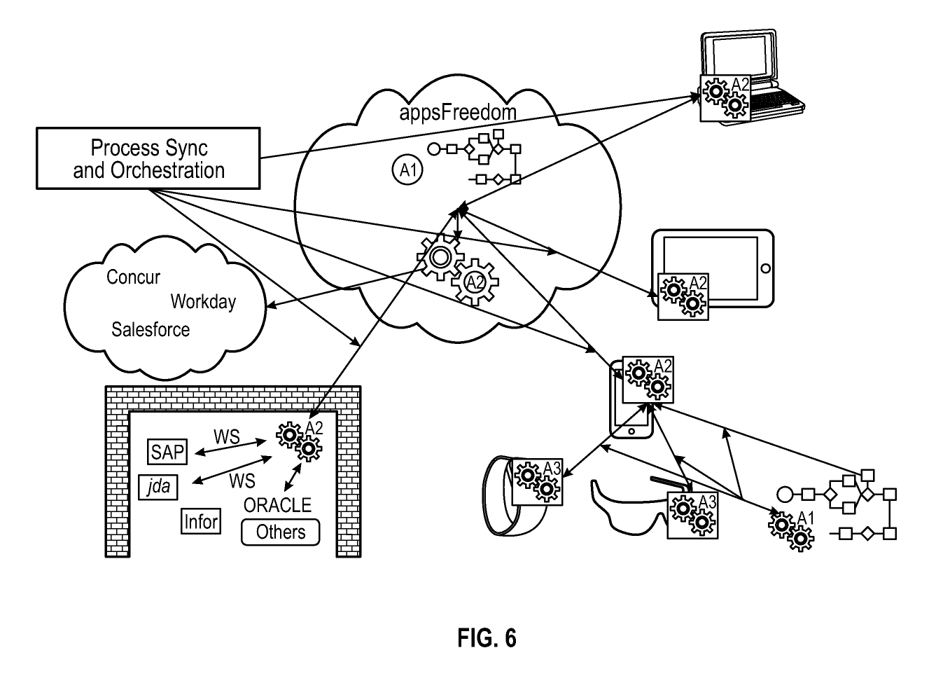

Referring to the drawings, FIG. 6 depicts an embodiment of an architecture of a delegated business process management for the Internet of Things world.

Elements of the architecture may comprise:

A1=The Business process designed and managed in one place like a Cloud application. Generally the Cloud application A1 may be a central application hosted by a cloud provider and delivered as a software-as-a-service (SaaS) application.

A2=Parts of the business process are executed in different platforms. For example and without limitation, different platforms A2 of the system architecture may be referred to as a multi-channel level that may include inside a firewall (On-Premise Applications), a computer, a tablet, a Smart Phone and different business application like SAP, Salesforce, Oracle, etc., wherein each includes a memory for storing data and software applications, a processor for executing software code and performing parts of the business process, a display for displaying information and requests regarding the BPM and an input mechanism for inputting data into the device for performing the business process. The A2 in some cases may integrate with other applications to get data.

A3=Parts of the business process are located underneath the level of A2 executed in different platforms, but controlled by A2 process. For example, and not by way of limitation, level A3 of the system may be referred to as a subsequent multichannel level wherein the business process may be executed in a Smart Watch, Smart Glasses & a Smart Car and is controlled and managed by an A2 process in the Smart Phone, wherein each includes a memory for storing data and software applications, a processor for executing software code and performing parts of the business process, a display for displaying information and requests regarding the BPM and an input mechanism for inputting data into the device for performing the business process. In this case, part of the management of the process is “delegated” to the Smart Phone.

A2 and A3 can also have multi-devices in each channel. For e.g., multiple Smart Watches and multiple Smart Glasses could be connected to the same Smart Phone. In this case, Smart Watch and Smart Glasses may be the Channel and the various individual Smart Watches and Smart Glasses may be Devices. In at least this way, the system, comprising of a central business process management system with multi-channels and multi-devices may be a delegated business process management system.

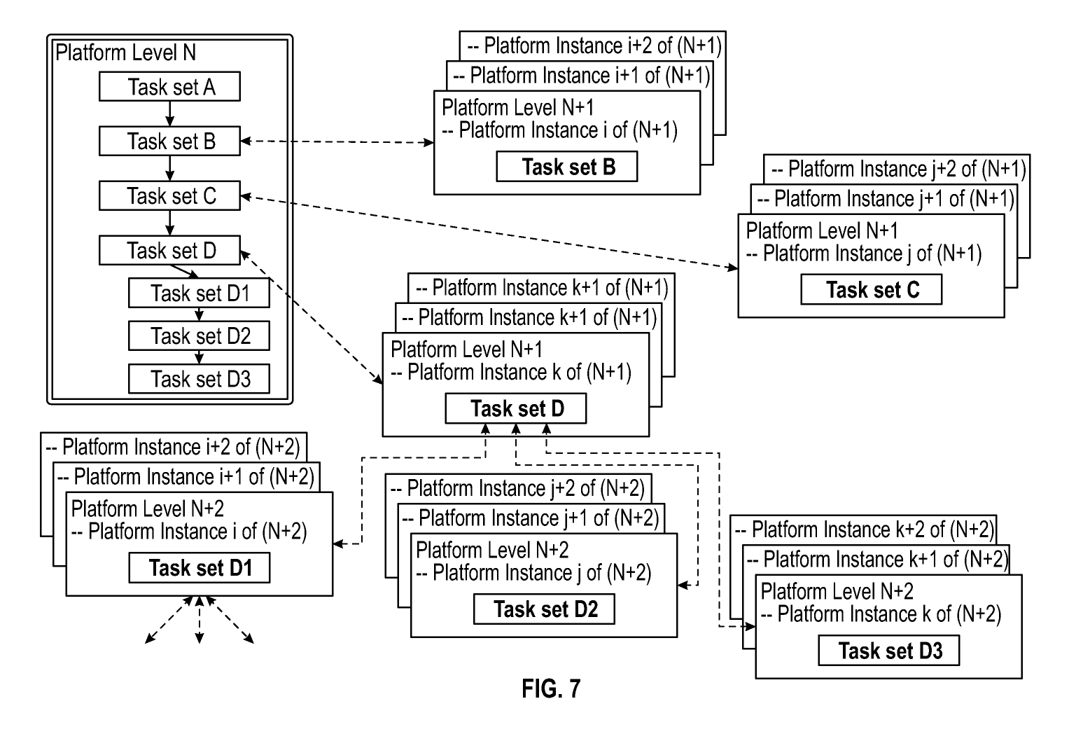

To provide a further example of the operation of a delegation business process management system, FIG. 7 depicts a delegated business process management. The business process may include a set of tasks, such as Task set A, Task set B, Task set C and Task set D. Task set D may also include sub-task sets, such as Task set D1, Task set D2 and Task set D3. The business process may be designed and managed in Platform Level N, where N represents an initial platform level, such as a Cloud platform level. In operation, Platform Level N can perform all of the Tasks and subtasks of the business process, but in order to more efficiently and effectively utilize technology and the growing technology in the JOT world, embodiments of the present invention provide for a delegated business process management. In the delegated business process management, Platform Level N can determine what Tasks need to be performed on the Platform Level N and which tasks can be delegated. In this example, Task set A is set to be performed on Platform Level N and Task set B, Task set C and Task set D are each delegated to Platform Level N+1.

In this example, Task set B is delegated to Platform Instance i of Platform Level N+1, Task set C is delegated to Platform Instance j of Platform Level N+1, and Task set D is delegated to Platform Instance k of Platform Level N+1. Platform Instances i, j and k are different types of platforms, referred as Multi-Channels, within Platform Level N+1, for example, a Smart Phone, a tablet, a laptop, etc. Within each Platform Instance, there may be additional instances, like Platform Instance i+1 and Platform Instance i+2, Platform Instance j+1 and Platform Instance j+2, and Platform Instance k+1 and Platform Instance k+2, referred as Multi-Devices. The various additional instances within each Platform Instance may represent differing operating systems within that type of Platform Instance. A Platform Instance is generally understood to be a computing device.

In operation, delegation of tasks from Platform Level N to Platform Level N+1 includes delegation of abilities for Platform Level N+1 to accomplish and complete the tasks. For example, Platform Instance i of Platform Level N+1 has been delegated Task set B and also delegated the ability and authorization to communicate with other systems, such as System A and System B in order to obtain data and/or other information necessary to complete Task set B. Further, Platform Instance j of Platform level N+1 has been delegated Task set C and also delegated the ability and authorization to communicate with other systems, such as System C to obtain data and/or other information necessary to complete Task set C. This is a shift from conventional business process management where all communications with other systems happen on the Platform Level N.

The delegation of ability and authorization is intended to mean the delegation of relevant business task information and relevant data for the subsequent platform to execute the task. This delegation of ability and authorization may also include delegating the power to a Platform Level to communicate with other systems in order to obtain any needed data and information to execute the task. The delegation of ability and authorization may also include the power to delegate one or more subtasks to another Platform Level, along with the relevant business task information and relevant data for the subsequent platform to execute the subtasks, including the power to communicate with other systems as needed. As shown in FIG. 2, Task set D has been delegated to Platform instance k of Platform Level N+1, which includes at least the ability and authorization to communicate with other systems and the ability and authorization to delegate sub tasks to Platform Level N+2 including the ability and authorization to communication with other systems to obtain data and/or information necessary to accomplish the sub-task.

For example, Task set D includes sub-tasks labeled as Task set DI, task set D2 and Task set D3. Task set D1 is delegated to Platform Instance i of Platform Level N+2, Task set D2 is delegated to Platform Instance j of Platform Level N+2, and Task set D3 is delegated to Platform Instance k of Platform Level N+2. Platform Instances i, j and k are different types of platforms (Multi-Channels) within Platform Level N+2, for example, a Smart Watch, a Smart Glasses, a Smart Car, etc. Within each Platform Instance, there may be additional instances, like Platform Instance i+1 and Platform Instance i+2, Platform Instance j+1 and Platform Instance j+2, and Platform Instance k+1 and Platform Instance k+2 (Multi-Devices). The various additional instances (Multi-Devices) within each Platform Instance (Multi-Channels) may represent differing operating systems within that type of Platform Instance.

In operation, delegation of sub-tasks from Platform Instance i of Platform Level N+1 to Platform Level N+2 includes delegation of abilities and authorizations for Platform Level N+2 to accomplish and complete the sub-tasks. For example, Platform Instance i of Platform Level N+2 has been delegated Task set D1 and also delegated the ability and authorization to communicate with other systems (represented by arrows in FIG. 2) in order to obtain data and/or other information necessary to complete Task set D1. Further, Platform Instance j of Platform Level N+2 has been delegated Task set D2 and Platform Instance K of Platform Level N+2 has been delegated Task set D3. This is a shift from conventional business process management where all communications with other systems happen on the Platform Level N.

Accordingly, as opposed to conventional business process management where any device operating on the various Platform Levels would need to communicate directly to Platform Level N through a user interface over a network connection in order to accomplish the tasks of the business process, embodiments of a delegated business process management allow for other devices to perform tasks that require only the ability of a particular device on a particular Platform Level to accomplish the tasks. It will be understood that according to embodiments, the delegated business process management system of the present invention can determine what devices are available on the various levels and delegate only to the levels that are available or that are needed in order to accomplish the task. Further, while it is shown that there are 3 Platform Levels, it is contemplated that additional Platform Levels may be possible and the delegation occurs in similar fashion throughout the Platform Levels and Platform Instances. This delegation of ability and authority to various devices along multiple Platform Levels allows for communication of device in the IOT world and opens up a multitude of possibilities for accomplishing business processes through delegation in order to provide for an effective and mobile approach to management of business processes.

Another embodiment of the present invention includes a method of operating a delegated business process management system. The method comprises designing and managing a business process having a plurality of tasks at a first platform level; delegating a task of the plurality of tasks from the first platform level with accompanying ability and authorization to a device of a particular platform instance of a second platform level, wherein the accompanying ability and authorization for the device of the second level includes the ability and authorization to communicate with other systems to obtain data and to delegate the ability and authorization to complete a sub-task to a third platform level; and delegating the sub-task from the device on the second platform level with accompanying ability and authorization to a device of a particular platform instance of the third platform level, wherein the accompanying ability and authorization includes the ability and authorization for the device of the third platform level to communicate with other systems to obtain data. The method may further comprise completing the tasks and sub-tasks on the respective platform level and communicating same to the first platform level.

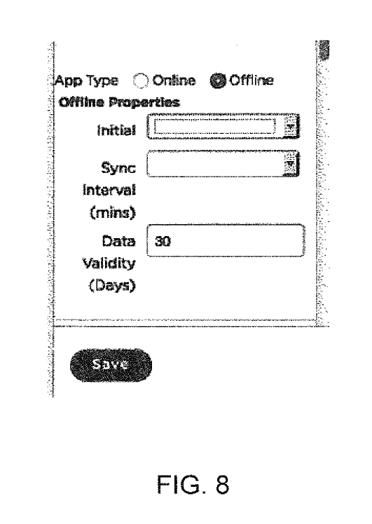

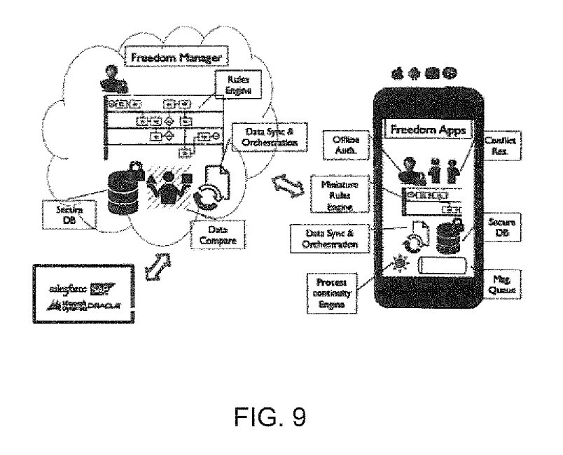

As shown in FIGS. 1-7 and described above, the delegated business management system may be incorporated into extended offline app generation shown in FIGS. 8 and 9.

Offline mobile apps are understood to be enterprise mobile apps that can work without any network connectivity to core IT applications. Offline apps can be categorized into two main categories.

The first category is a short network loss. Offline apps in this category can work offline during intermittent network loss. In other words, these apps need to work offline for a few minutes, so that the user's workflow process is not interrupted due to network loss. For example, and without limitation, when a user is working in a train or under a bridge or inside an indoor parking lot, the network can be spotty and the user needs to continue working irrespective of network availability.

The second category is an extended network loss. Offline apps in this category need to work without any network connectivity for extended period of time, typically hours and days. For example, and without limitation, a utility service engineer needs to repair electrical grid after a storm or hurricane where certain areas may not have connectivity for hours or days. Another example may be a maintenance engineer doing repair work in an oil rig in offshore drilling scenario. The apps in this category are typically called extended offline mobile apps, because they are built to handle extended network loss are complex and more sophisticated in nature.

Embodiments of the present invention allows non-professional programmers build extended offline mobile apps using a codeless development environment, to generate robust, sophisticated offline mobile apps that works on all devices—from a smartphone to a Tablet across various operating systems such as but not limited to iOS, Android, Windows and Blackberry.

Offline apps are generated in 2 main steps:

Step 1: App definition. This step is done in the app development process, where the app type is chosen and a few parameters are given, as shown in FIG. 8. This indicates to the platform that the app generated needs to be an offline app and the platform does the needful during the app generation process. This app definition process is typically executed by the developer. Referring to FIG. 8, App Type: Indicates the type of App—Online or Offline app; Initial: Indicates the initial data synchronization process between apps and the server, Sync Interval: Indicates the interval between data synchronizations; and Data Validity: Indicates the validity of data in the device, in the event it is not synchronized back to the server.

Step 2: App Generation. This step is executed by the platform based on the properties set by the app developer in Step 1. Steps 1-5 as described above are incorporated herein as sub-steps of Step 2 in order to generate the offline mobile app. Additionally, there are several engines generated in run-time for an extended offline app as described below.

The extended offline app has components generated inside the app (residing in the device) as well as on the Server (Freedom Manager).

### Device Components

The device components to support extended offline apps include at least the following:

Authentication engine: Passcode authentication for end users in offline mode; 4 digit numeric passcade; and Pattern-based passcode.

Conflict resolution engine: Provides server conflicts to end-user before posting it in backend application; Works in data comparison engine with Freedom Manager; and Enables guided conflict resolution procedures for end users.

Business rules engine: Primary device component to provide extended offline capabilities; Miniature rules engine in device to process business rules; Lean and mean rules engine designed to work under given constraints of a mobile device (e.g. power consumption, processing power, memory and disk space availability, etc.); and Works with meta data from server.

Data synchronization engine: Used to synchronize data between apps and backend applications; and Automated, scheduled data sync and/or manual data sync triggered by end user.

Data orchestration engine: Used to orchestrate data synchronization based on business rules; and Supports different data orchestration rules for data upload and download.

Device database: Cross-platform device database; Standalone, no human touch required for database operations; and Not limited by browsers or 3rd party software for database size or any other operation.

Message Queue: Used to queue data updates to backend application; Displays pending and conflict queues to end user; and Used in conflict resolution for data playback.

Process continuity engine: Major component contributing to extended offline apps; and Enables continuity of business process across apps for offline apps.

Data cleanup engine: Keeps track on un-synchronized data in device; and Identifies stale data and purges data, as appropriate.

### Server Components

The server components that are generated to support offline apps include at least the following:

Data synchronization engine: Used to synchronize data between server and apps as well as server and backend applications; and Automated, scheduled data sync and/or manual data sync triggered by end user.

Data orchestration engine: Used to orchestrate data synchronization based on business rules; and Supports different data orchestration rules for data upload and download.

Data comparison engine: Used to compare data coming in from different apps and/or devices; and Triggers a conflict in case of data difference.

Rules engine: Distributed rules engine (as discussed with regard to FIGS. 6-7).

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

What is claimed is:

1. A method of automatically generating an app with an app generation system, the method comprising:
defining an app type;
defining a business process using a logical process model;
automatically generating an app for a plurality of device operating systems and browsers in response to activating an app generation software application;
enhancing the visual aspects of screens of the generated app;
building integration logic using a drag and drop interface;
publishing and managing the generated app; and
analyzing user behavior, wherein the generation of the app includes providing automatic reporting of user behavior in use of the generated app.

2. The method of claim 1, comprising defining the app to be an offline app.

3. The method of claim 1, wherein the operating systems comprises a plurality of mobile operating systems and mobile browsers.

4. The method of claim 1, wherein enhancing the visual aspects of the screens includes using a drag and drop interface for dragging and dropping mobile components into the user interface.

5. The method of claim 4, wherein enhancements made in one operating system of the app applies to all operating systems of the app.

6. The method of claim 4, further comprising reviewing app enhancements in real-time by business users from their devices for real-time feedback to the app developer.

7. The method of claim 1, wherein building integration logic using a drag and drop interface comprises connecting the app to one of a cloud based backend application or an on-premise back-end application when required by the app.

8. The method of claim 1, wherein publishing and managing the generated app comprises assigning administration task leveraged from one of the cloud based backend application or the on-premise back-end application.

9. The method of claim 1, wherein the app operates on a delegated business process management for an Internet of Things allowing one or more devices to delegate performance of a task to another device.

10. The method of claim 9, comprising designing and managing a plurality of tasks of the business process within a first platform level, wherein the first platform level delegates a task with accompanying ability and authorization to a device of a particular platform instance of a second platform level.

11. The method of claim 9, wherein the accompanying ability and authorization for the device of the second level includes the ability and authorization to communicate with other systems to obtain data and to delegate the ability and authorization to complete a sub-task to a device of a third platform level.

12. The method of claim 11, wherein the device of the third platform level communicates with other systems to obtain data.

13. The method of claim 2 comprising, providing an authentication engine for end users of the offline app.

14. The method of claim 2 comprising, providing a conflict resolution engine to resolve conflicts before posting.

15. The method of claim 2 comprising, providing a business rules engine to process business rules and allow the offline app to function under restraints of a mobile device storing the offline app.

16. The method of claim 2 comprising, providing a data synchronization engine to synchronize data between the offline app and backend applications.

17. The method of claim 2 comprising, providing a data orchestration engine to orchestrate data synchronization based on business rules.

18. The method of claim 2 comprising, providing a messaging queue to queue data updates to backend applications.

19. The method of claim 2 comprising, providing a process continuity engine.

20. The method of claim 2 comprising, providing a data clean-up engine to keep track of unsynchronized data, identifies stale data, and purges data as appropriate.
